(19) United States
(12) Patent Application Publication
(10) Pub. No.: US 2013/0306351 A1
(43) Pub. Date: Nov. 21, 2013

(54) INSULATED ELECTRIC CABLE

(71) Applicants: Yves-Julien Lambert, Chaumont-Gistoux (BE); Jacques Jean Francois Joseph Schombourg, Cossonay-Ville (CH)

(72) Inventors: Yves-Julien Lambert, Chaumont-Gistoux (BE); Jacques Jean Francois Joseph Schombourg, Cossonay-Ville (CH)

(73) Assignee: Ineos Manufacturing Belgium NV, Antwerpen (BE)

(21) Appl. No.: 13/982,637

(22) PCT Filed: Feb. 2, 2012
(86) PCT No.: PCT/EP12/51782

§ 371 Date: Jul. 30, 2013

(30) Foreign Application Priority Data
Feb. 4, 2011 (EP) 11153321.2

(51) Int. Cl. H01B 7/00

(52) U.S. Cl. CPC H01B 7/00
USPC 174/120 SC

(57) ABSTRACT

An insulated cable is disclosed which comprises an electrical core conductor (1) having arranged coaxially around it at least three extruded layers of polymer-based material, which layers comprise an insulating layer (3) comprising a copolymer of polyethylene and an acrylate, an outer layer (5) of a semi-conductive material, and an intermediate layer (4) between the insulating and outer layers which comprises polyethylene and is substantially free of any acrylate or conducting material, such that the outer layer (5) is strippable from the intermediate layer (4).

The present invention relates insulated electric cables, and in particular to laminated constructions comprising coextruded layers of polymer-based materials in which two adjacent layers are strippably bonded together.

The construction of insulated electrical conductors, eg wire and cable, is well known in the art. For medium and high voltage applications, the cable generally comprises a central core conductor of one or more metal strands surrounded coaxially by (in sequential order) a semi-conductive polymeric shielding layer, a polymeric primary insulation layer and an outer semi-conductive polymeric shielding layer overlying the insulation. An outer metallic conductor (eg neutral conductor) overlying or embedded in the outer semi-conductive shielding may also be present, eg in the form of braided wires or metal tape. The cable may also be provided with armoured covering and additional layers to provide weather protection or increased mechanical strength. Generally the annular surfaces of the polymeric layers are smooth and substantially concentric, and therefore the layers are typically formed by extrusion.

The inner semi-conductive polymeric shielding layer, the polymeric primary insulation layer and the overlying semi-conductive shielding layer of an electric cable form a coaxial laminated structure and are generally applied to the metallic conductor using extrusion coating techniques which are well known in the art.

In order to facilitate easy splicing or terminating of cables, the outer semi-conductive shielding layer is generally designed so as to be relatively easily strippable from the primary insulation layer leaving little or no conductive residue adhering to the primary insulation and without damaging the surface of the primary insulation. However, the outer semi-conductive shielding layer also needs to be sufficiently bonded to the primary insulation so that the two layers do not separate during installation and conventional use and so that the ingress of contaminants, such as air or water, between the layers is avoided.

Combinations of primary insulating materials and semi-conductive shielding materials having the desired mutual adhesion/stripping characteristics have been developed and are used commercially. However, the known combinations have some problems. For example, if the semi-conductive shielding layer used is relatively hard, it is often quite difficult to strip it from the primary insulation and a hand tool may have to be used to cut through the semi-conductive shielding layer to the primary insulation in order to facilitate removal. The use of such a tool to cut through the semi-conductive shielding layer may cause damage to the outer surface of the primary insulation. If the semi-conductive shielding layer is relatively soft, it may tend to tear as it is being stripped from the primary insulation.

Problems can also arise because of the composition of adjacent layers. In some countries the standard composition for the insulating layer is low density polyethylene (LDPE) containing an acrylate copolymer such as ethyl butacrylate (EBA) or methyl methacrylate (MMA), as well as peroxide and antioxidants. The semiconductor shielding layer which is strippably bound to it typically comprises LDPE containing EBA, ethyl ethacrylate, nitrile butadiene rubber or ethyl vinyl acetate (EVA) together with carbon black, which provides the semiconducting properties, as well as peroxide and antioxidants.

U.S. Pat. No. 4,767,894 discloses an insulated electric cable having a laminated construction comprising an electrical core conductor surrounded by at least three extruded layers of polymer-based material in which an intermediate layer between a first layer and a second layer is strippably bonded to the first layer and fully bonded to the second layer, such that the second layer together with substantially all of the intermediate layer is readily strippable from the first layer. The first layer is an inner layer of insulating material such as crosslinked polyethylene, the intermediate layer is a semi-conductive shielding material or an insulating material, and the second layer is an outer layer of a semi-conductive shielding material. There is preferably a further inner layer of a semi-conductive shielding material between the electrical core conductor and the first insulating layer. The second and inner semi-conductor layers may comprise low density polyethylene, linear low density polyethylene, ethylene/vinyl acetate copolymer, ethylene/ethyl acrylate copolymer, high density polyethylene, EPDM and blends of these materials, plus a conductor such as carbon black. The intermediate layer, which must be strippable from the first layer, may comprise ethylene/vinyl acetate copolymer, ethylene/ethyl acrylate copolymer, acrylonitrile rubbers, alloys of above mentioned polymers or blends of these copolymers with low density polyethylene or linear low density polyethylene, as well as a conductor if the layer is semiconducting. A preferred composition for this layer is a blend comprising ethylene/vinyl acetate copolymer and acrylonitrile rubber.

Constructions such as that described in U.S. Pat. No. 4,767,894 are well known. In some European countries there is now a standard specification which requires the inner layer of insulating material to be low density polyethylene containing 1.5-3 wt % butyl acrylate, vinyl acrylate, ethyl acrylate or methyl acrylate comonomer, crosslinked with peroxide. The presence of the acrylate copolymer is required in order to improve the water tree resistance of the insulating layer. Poor water tree resistance means that cables in which the insulating layer comprises only polyethylene will not pass the current long duration wet electrical test standard.

In cases where the inner insulating layer contains acrylate comonomer, it can be difficult to strip this from the inner layer, or alternatively to strip an outer layer from this layer, due to the strength of the bonding between this layer and the layers inside and outside. This can be addressed by ensuring that the inner insulating layer does not contain an excessive level of acrylate. In U.S. Pat. No. 6,282,374 the insulating layer comprises only polyethylene, and the outer semiconductor layer is therefore strippable. However with no acrylate in the insulating layer such an arrangement is likely to have poor water tree resistance, and its use may not be permitted in some European countries as mentioned above. Therefore an alternative solution which provides strippability as well as good water tree resistance is required.

We have now found that strippability of the outer semiconductor layer from an inner insulating layer can be improved whilst at the same time maintaining good water tree resistance if an intermediate layer comprising polyethylene substantially free of any acrylate or conducting material is provided between the inner insulating layer containing acrylate and the outer semiconductor layer.

Accordingly in a first aspect the present invention provides an insulated cable comprising an electrical core conductor having arranged coaxially around it at least three extruded layers of polymer-based material, which layers comprise an insulating layer comprising a copolymer of polyethylene and an acrylate, an outer layer of a semi-conductive material, and an intermediate layer between the insulating and outer layers which comprises polyethylene and is substantially free of any acrylate or conducting material, such that the outer layer is strippable from the intermediate layer.

Preferably the cable additionally comprises an inner layer of a semi-conductive material between the core conductor and the insulating layer.

The cable usually additionally comprises a further protective layer outside the outer layer which provides physical protection for the cable. This is added subsequently in a separate process.

By “strippable” is meant throughout this specification that the relevant layers are capable of being cleanly peeled apart by manual means. The terms “inner layer” and “outer layer” as used in this specification in relation to an insulated cable define the relative position of the layer with respect to the electrical core conductor; “inner” means closer to the core conductor and “outer” means further from the core conductor.

The intermediate layer is a polyethylene which may have a density between 850 and 975 kg/m³, but preferably it comprises at least 95 wt % polyethylene having a density below 940 kg/m³. More preferably it comprises at least 95 wt % polyethylene having a density below 925 kg/m³, and more particularly below 920 kg/m³, which is referred to hereinafter as low density polyethylene (LDPE). Optionally the intermediate layer may also contain an antioxidant, and optionally also a crosslinking agent such as peroxide, and an antioxidant. The peroxide and antioxidant may be added to increase thermal resistance, or even if not added may migrate from the adjacent layers into the inteiniediate layer.

The outer layer of semi-conductive material is preferably crosslinked and can be fabricated from any suitable polymeric composition such as low density polyethylene, linear low density polyethylene, ethylene/vinyl acetate copolymer, ethylene/alkyl acrylate copolymer where the alkyl acrylate is preferably ethyl or butyl acrylate, high density polyethylene, acrylonitrile rubber, EPDM and blends of these materials. To render the composition for the outer layer semi-conductive, it is necessary to include in the composition an electrically conductive material. The employment of carbon black in semi-conductive shielding compositions is well known in the art and any such carbon black in any suitable form can be employed in the outer layer, including furnace blacks and acetylene blacks.

The crosslinking is usually carried out using peroxide. Most preferred is an ethylene/vinyl acetate copolymer containing carbon black and crosslinked with peroxide.

The optional inner layer of semi-conductive material is preferably crosslinked and can be fabricated from any suitable polymeric composition, such as low density polyethylene, linear low density polyethylene, ethylene/vinyl acetate copolymer, ethylene/alkyl acrylate copolymer where the alkyl acrylate is preferably ethyl or butyl acrylate, high density polyethylene, acrylonitrile rubber, EPDM and blends of these materials. The polymer contains a conductor, preferably carbon black in any suitable form. The crosslinking method may utilise a silane, but it is preferably carried out using peroxide. This layer may have the same or a different composition from that of the outer layer. Most preferred is an ethylene/butyl acrylate copolymer containing carbon black and crosslinked with peroxide.

The insulating layer is preferably crosslinked, optionally utilising a silane, but most preferably using peroxide. It is preferably an ethylene/alkyl acrylate copolymer in which the alkyl acrylate is butyl acrylate or methyl methacrylate, and in particular a low density polyethylene containing an ethylene/butyl acrylate copolymer and crosslinked with peroxide. When the insulating layer is a low density polyethylene containing an ethylene/butyl acrylate copolymer and crosslinked with peroxide, it preferably has a density of 910-940 kg/m³, preferably 910-930 kg/m³ and most preferably 915-925 kg/m³. Its melt index MI₂ is preferably between 0.2 and 5 g/10 min. more preferably 0.5-4 g/10 min and most preferably 0.5-2.5 g/10 min. The acrylate content in the copolymer is preferably 0.5-5 wt %, more preferably 1-4 wt % and most preferably 1.5-3 wt %.

Preferably, the same method of crosslinking is used for each crosslinked layer so that only one crosslinking step is required e.g. all the layers are peroxide crosslinked or all silane crosslinked.

Preferably the force required to strip the outer layer from the intermediate layer at a 180° angle of pull is from 2 to 60N per cm as measured by the French Standard HN 33-S-23 from Electricite de France (EdF), and most preferably from 5 to 25N per cm.

French Standard HN 33-S-23 relates to a test for removing the semiconductor shield from an insulating sheath. The principle of the test is to measure the force required to remove 50 mm of a strip of semiconductor shield from the insulating shield by pulling the strip substantially in the axis of the cable, at an angle of 180° to its initial orientation. The test piece, about 150 mm long, is prepared in the follow manner. A strip of the assembly formed by the insulating material and the internal and external semiconductor shields having a length of 150 mm and a width, measured on the side of the external semiconductor shield, of 10 mm is removed from the cable. The external semiconductor shield of the strip is removed by hand before the test over a portion of its length, so as to leave the insulating material and semiconductor shield adhering over 50 mm. In the removed part the insulating material of the cable can if necessary be cut to facilitate being seized in the jaw of the pulling machine. The test temperature are: 0° C., 20° C. and 40° C. The test piece is introduced into the pulling machine, the insulating material of the cable being gripped in one of the jaws of the apparatus and the external semiconductor shield, folded 180° on itself, being gripped in the other jaw. The assembly is installed either in a cold enclosure or in a stove, until the temperature of the sample becomes stabilized at the value specified for the test, with a tolerance of +/−2° C. The strip of the semiconductor shield is pulled at a speed of 50 mm/min. The removal force is continuously recorded as a function of the distance apart of the pulling machine jaws. The peak value obtained at the start of the test (maximum value) and the value obtained when conditions have been established are recorded.

For general purpose medium voltage and high voltage cable, the absolute thickness of the intermediate layer is generally lie in the range 10 to 1000 μm, preferably from 50 to 200 μm. The most preferred range of thickness is 70-130 μm. The ratio of the thickness of the outer layer to the thickness of the intermediate layer is preferably in the range 20:1 to 1:1.

The insulation layer, semi-conductive layer(s) and intermediate layer can be applied to the cable by conventional means, for example by tandem extrusion or coextrusion techniques. Preferably the insulating, intermediate and outer layers are simultaneously coextruded. In the most preferred embodiment a cable comprises a metallic core conductor surrounded by an inner semi-conductive layer, with the insulating, intermediate and outer layers being simultaneously co-extruded onto this additional semi-conductive layer.

The insulated cable according to the present invention may have other conventional layers such as for example a neutral conductor, armoured covering and weather protection coatings.

Because the intermediate layer is substantially free of any acrylate or conducting material, the outer layer is generally easily strippable from the intermediate layer without tearing. If a conventional cutting tool is used to faciliate the start of the stripping, the cutting edge may be adjusted so that it only cuts through the outer layer, thus avoiding damage to the intermediate and insulating layers.

Furthermore, in the present invention, unlike in U.S. Pat. No. 4,767,894, the insulating layer is not one of the two layers which have to be stripped apart. This has the advantage that the composition of the insulating layer does not have to be designed to ensure good strippability. For example, if desired it can contain a relatively high level of acrylate, which has the advantage of providing improved water tree resistance. However higher levels of acrylate also make stripping much more difficult, and could therefore cause significant problems if the outer layers had to be stripped from the insulating layer.

The present invention will be described in more detail with reference to the accompanying drawing, which shows a cross-section through an insulated cable according to the invention.

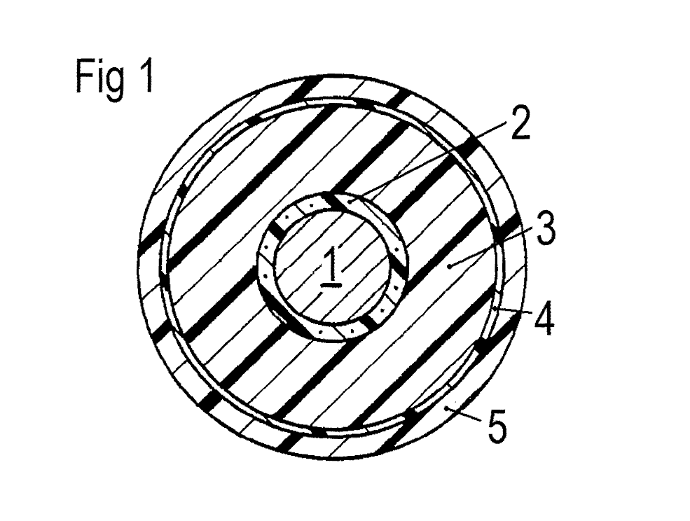

FIG. 1 illustrates in cross-section a medium voltage power cable according to the present invention. A central conductor 1 is surrounded sequentially by:
an inner layer of semi-conductive material 2;
an insulating layer 3;
an intermediate layer 4;
an outer layer of semi-conductive material 5.

The outer layer 5 is strippably bonded to the intermediate layer 4, which is bonded to the insulating layer 3. Thus the outer layer 5 can be cleanly peeled from the intermediate layer 4 by manual means. The layers 3, 4 and 5 can be extruded using known techniques. All four layers can be extruded using four separate extruders in tandem, but generally at least two of the layers and preferably the outer three layers are co-extruded.

### EXAMPLES

The manufacture of electrical cable insulation was modelled by preparing laminated compression moulded sheets.

The insulation material (layer 3 in FIG. 1) consisting of 75 wt % low density polyethylene and 25 wt % EBA was first extruded and pelletized in a twin screw extruder with a melting point at 125° C. The pellets were soaked for 1 hour at 80° C. with 0.3% antioxidant (KV10 from BASF) and 1.7% of t-butyl cumyl peroxide (Trigonox T from Akzo Nobel).

Sheets were prepared by moulding 80 g of the material in a cavity mould of dimensions 210 mm×140 mm×3 mm. The mould was placed in a press which had been preheated to 125° C. After 5 minutes at a pressure of 2 bar, the pressure was increased to 200 bar and after further 5 minutes, the mould was cooled at a rate of approximately 20° C./min at the same pressure. This method of preparing the moulded sheet did not cross-link the insulating material.

Sheets of non-crosslinked semi-conductive outer layer material (layer 5) were also prepared by moulding under the same conditions 35 g of material in a cavity mould of dimensions 210 mm×140 mm×1 mm. The thickness of the sheets of the intermediate layer (4^{th} layer) was 100 μm prepared by a cast film extrusion process.

The insulation material used for layer 3 was a blend of commercially available LDPE and EBA, the blend having a density between 915-925 kg/m³, a melt index between 0.5 and 2.5 g/10 min and a total butyl actylate content between 1.5 and 3 wt %.

The intermediate layer (layer 4) was commercially available product LDPE 23H430 from lneos O&P Europe, having a density of 923 kg/m³.

Two different materials were used to prepare the semi-conductive outer layer (layer 5); E8572 “strippable semi-conductive” and E8413 “easy strippable semi-conductive shielding”, both ethylene/vinyl acetate copolymers containing some nitrile rubber, commercially available from Trelleborg SE-331 29 Värnamo, Sweden.

For Examples 1 and 2, laminated sheets were prepared by placing in a mould a sheet of the insulation material (layer 3), followed by a sheet of the semi conductive outer layer (layer 5). No intermediate layer was present.

For Examples 3 and 4, laminated sheets were prepared by placing in a mould a sheet of the insulation material (layer 3), followed by a sheet of the intermediate layer (layer 4), and finally a sheet of the semi conductive second layer (layer 5).

For Examples 1 and 2, a strip of polyester film was included between the insulation layer 3 and the outer semi-conductive layer 5 along one edge to separate the two layers for a length of approximately 30 mm. For Examples 3 and 4, an identical polyester film was instead placed between the intermediate layer 4 and the outer semi-conductive layer 5.

The laminated sheets of all four Examples were then cross-linked by first preheating for 1 minute at 125° C. at a pressure of 5 bar, then for a further 2 minutes at a pressure of 20 bar, 2 minutes at a pressure of 100 bar, and finally heating to 180° C. at 100 bar for 20 minutes before cooling at the same pressure at a rate of approximately 20° C./min.

The cross-linked laminated sheets were then heat treated for 24 hours at 50° C.

Tensile bars according to ISO 1 A were cut from the cured plaques in order to determine the force required to strip the outer semi-conductive layer (5) from the insulation material (3) in the case of Examples 1 and 2, and from the intermediate layer (4) in the case of Examples 3 and 4.

The polyester film separating the layers was removed. The free edges of the layers were pulled apart slightly to initiate the stripping. The free ends were mounted in the grips of a tensile testing machine and the stripping force determined according to the French Standard of Electricite de France (Edf) HN 33-S-23 (initial separation between grips 1.5 cm, rate of separation of grips 50 mm minute). The results are given in Table 1.

TABLE 1

| EXAM- | | | | Stripping |
|---|---|---|---|---|
| PLE | Layer 3 | Layer 4 | Layer 5 | Force (N) |
| 1 | LDPE/EBA | — | Trelleborg E8572 | 16.10 |
| 2 | LDPE/EBA | — | Trelleborg E8413 | 9.18 |
| 3 | LDPE/EBA | 100 μm LDPE | Trelleborg E8572 | 8.08 |
| 4 | LDPE/EBA | 100 μm LDPE | Trelleborg E8413 | 5.81 |

The results show that the intermediate layer 4 has a significant effect on the strippability of the outer semi-conducive layer. The values of the stripping force decrease respectively from 16.10N to 8.08N and from 9.18N to 5.81N for the two different outer semiconductive layers. The intermediate layer 4 of Examples 3 and 4 did not itself contain a peroxide cross-linking agent, but was cured by diffusion of the cross-linking agent from the insulation layer and outer semi-conductive layer, each of which did contain a peroxide cross-linking agent. This method of curing the intermediate layer avoids or at least mitigates the problem of “scorching”, i.e. premature cross-linking, arising from high shear of the relatively thin intermediate layer in the die.

1-13. (canceled)

14. Insulated cable comprising an electrical core conductor (1) having arranged coaxially around it at least three extruded layers of polymer-based material, which layers comprise an insulating layer (3) comprising a copolymer of polyethylene and an acrylate, an outer layer (5) of a semi-conductive material, and an intermediate layer (4) between the insulating and outer layers which comprises polyethylene and is substantially free of any acrylate or conducting material, such that the outer layer (5) is strippable from the intermediate layer (4).

15. Cable according to claim 14, which additionally comprises an inner layer (2) of a semi-conductive material between the core conductor (1) and the insulating layer (3).

16. Cable according to claim 14, wherein the intermediate layer comprises at least 95 wt % polyethylene having a density below 940 kg/m3.

17. Cable according to claim 14, wherein the intermediate layer comprises at least 95 wt % polyethylene having a density below 925 kg/m3.

18. Cable according to claim 14, wherein the intermediate layer comprises at least 95 wt % polyethylene having a density below 920 kg/m3.

19. Cable according to claim 14, wherein the insulating layer is an ethylene/alkyl acrylate copolymer in which the alkyl acrylate is butyl acrylate or methyl methacrylate, preferably a low density polyethylene containing an ethylene/butyl acrylate copolymer and crosslinked with peroxide.

20. Cable according to claim 14, wherein the insulating layer is an ethylene/alkyl acrylate copolymer in which the alkyl acrylate is butyl acrylate or methyl methacrylate, crosslinked with peroxide.

21. Cable according to claim 20, wherein the ethylene/alkyl acrylate copolymer has a density of 910-940 kg/m3, a melt index MI2 of 0.2-5 g/10 min, and an acrylate content in the copolymer 0.5-5 wt %.

22. Cable according to claim 14, wherein the outer layer is selected from low density polyethylene, linear low density polyethylene, ethylene/vinyl acetate copolymer, ethylene/alkyl acrylate copolymer where the alkyl acrylate is preferably ethyl or butyl acrylate, high density polyethylene, acrylonitrile rubber, EPDM or blends thereof.

23. Cable according to claim 14, wherein the outer layer comprises an ethylene/vinyl acetate copolymer containing carbon black and crosslinked with peroxide.

24. Cable according to claim 14, wherein the force required to strip the outer layer from the intermediate layer at a 180° angle of pull is from 2 to 60N per cm as measured by the French Standard HN 33-S-23 from Electricite de France (EdF).

25. Cable according to claim 14, wherein the absolute thickness of the intermediate layer is between 50 and 200 μm.

26. Cable according to claim 14, wherein the ratio of the thickness of the outer layer to the thickness of the intermediate layer is in the range 20:1 to 1:1.
